(19) United States
(12) Patent Application Publication
(10) Pub. No.: US 2017/0242612 A1
(43) Pub. Date: Aug. 24, 2017

(54) PROCESS DATA BINNING FOR MEMORY SWAPPING

(71) Applicant: Qualcomm Innovation Center, Inc., San Diego, CA (US)

(72) Inventors: William Kimberly, San Diego, CA (US); Venkatakrishnan Gopalakrishnan, San Diego, CA (US); Ajay Iyengar, San Diego, CA (US)

(21) Appl. No.: 15/436,792

(22) Filed: Feb. 18, 2017

Related U.S. Application Data
(60) Provisional application No. 62/296,882, filed on Feb. 18, 2016.

(51) Int. Cl. G06F 3/06

(52) U.S. Cl. CPC G06F 3/0631; G06F 3/061; G06F 3/064; G06F 3/0685

(57) ABSTRACT

A method for using volatile and non-volatile computer memory may comprise dividing at least a portion of the non-volatile computer memory into a plurality of bins, wherein each bin comprises a plurality of contiguous blocks of physical memory in the non-volatile memory. The method may further comprise assigning one or more processes to each of the plurality of bins, storing a process ID with metadata of a page belonging to the one or more processes, matching the page to one of the plurality of bins based on the process ID, and writing the page to a matched one of the plurality of bins.

### PRIORITY

This application claims priority to U.S. Provisional Application No. 62/296,882, filed Feb. 18, 2016 and entitled PROCESS DATA BINNING FOR MEMORY SWAPPING, which is incorporated herein by reference.

### FIELD

The present invention relates to memory performance in computer operating systems. In particular, but not by way of limitation, the present invention relates to organizing data placement in swap storage in computer operating systems.

### BACKGROUND

In computer operating systems, active computer programs typically utilize volatile memory known as random access memory, or RAM. When a user uses many programs, or a particular program requires a high amount of RAM, various methods are utilized to free up more available RAM. One of these methods includes temporarily offloading data from RAM to an area in non-volatile storage that is typically known as “swap.” The particular data that gets offloaded to swap in non-volatile storage at any given time is usually data that is not actively needed by a running program at that particular time. When the data that is offloaded is needed again by a running program, the data is loaded from swap in non-volatile storage back into RAM.

Many operating systems use non-volatile storage media (including flash-based non-volatile storage media), which are also known as solid state drives. While flash storage provides many performance benefits over hard disk drive storage, these performance benefits are most useful when the flash storage is used for large, sequential accesses. However, some operating systems, such as Linux, use a Memory Management subsystem that tends to result in small, random accesses from swap to RAM, getting slow performance from the storage media. As a result, the methods used to access data from swap in Linux systems with flash storage can be slow and may become even slower over time. Therefore, a need exists for ways to optimize accesses from swap to RAM to improve overall performance.

### SUMMARY

An aspect of the present disclosure provides a method for using volatile and non-volatile computer memory. The method may comprise dividing at least a portion of the non-volatile computer memory into a plurality of bins, wherein each bin comprises a plurality of contiguous blocks of physical memory in the non-volatile memory. The method may further comprise assigning one or more processes to each of the plurality of bins, storing a process ID with metadata of a page belonging to the one or more processes, matching the page to one of the plurality of bins based on the process ID, and writing the page to a matched one of the plurality of bins.

Another aspect of the disclosure provides a computing device which may comprise volatile memory, non-volatile memory, and a hardware processor configured to execute a memory management subsystem that performs a method for utilizing the volatile memory and non-volatile memory. The method may comprise dividing at least a portion of the non-volatile computer memory into a plurality of bins, wherein each bin comprises a plurality of contiguous blocks of physical memory in the non-volatile memory. The method may further comprise assigning one or more processes to each of the plurality of bins, storing a process ID with metadata of a page belonging to the one or more processes, matching the page to one of the plurality of bins based on the process ID, and writing the page to a matched one of the plurality of bins.

Yet another aspect of the disclosure provides a non-transitory, tangible computer readable storage medium, encoded with processor readable instructions to perform a method for using volatile and non-volatile computer memory. The method may comprise dividing at least a portion of the non-volatile computer memory into a plurality of bins, wherein each bin comprises a plurality of contiguous blocks of physical memory in the non-volatile memory. The method may further comprise assigning one or more processes to each of the plurality of bins, storing a process ID with metadata of a page belonging to the one or more processes, matching the page to one of the plurality of bins based on the process ID, and writing the page to a matched one of the plurality of bins.

### BRIEF DESCRIPTION OF THE DRAWINGS

FIG. 1 shows how virtual memory may be used to map virtual memory addresses to physical memory addresses in volatile and non-volatile memory.

FIG. 2 illustrated data structures in volatile memory that are used to manage memory access in operating systems, including a page directory and lists.

FIG. 3 illustrates and aspect of the present disclosure showing how pages of a process are organized into bins in swap.

FIG. 4 illustrates how pages of processes are written to swap in a sequential manner and how, according to the present disclosure, pages of the same processes are written to the same bins in swap.

FIG. 5 is a logical block diagram of components of a computing device which may implement aspects of the present disclosure.

FIG. 6 is a flowchart which may be traversed to depict a method for memory management in accordance with the present disclosure.

FIG. 7 is a logical block diagram of another embodiment of a computing device which may implement aspects of the present disclosure.

### DETAILED DESCRIPTION

In kernels of operating systems such as Linux, memory management subsystems utilize virtual memory, which is a memory management technique known in the art that maps physical addresses in computer memory to virtual addresses. Virtual memory allows a particular process to operate as if its data were located in physical memory as one contiguous address space, even though the data may actually be located in non-contiguous physical address spaces. Virtual memory works in part by dividing up data from processes into same-size blocks known as pages, and by using a page table that maps virtual addresses to physical addresses. A common page size used for blocks of data in Linux and other operating systems is 4 KB, though other page sizes may be used without departing from the present disclosure. Since a page is comprised of data used for a process, the terms “page” and “data” may be used somewhat interchangeably throughout the disclosure.

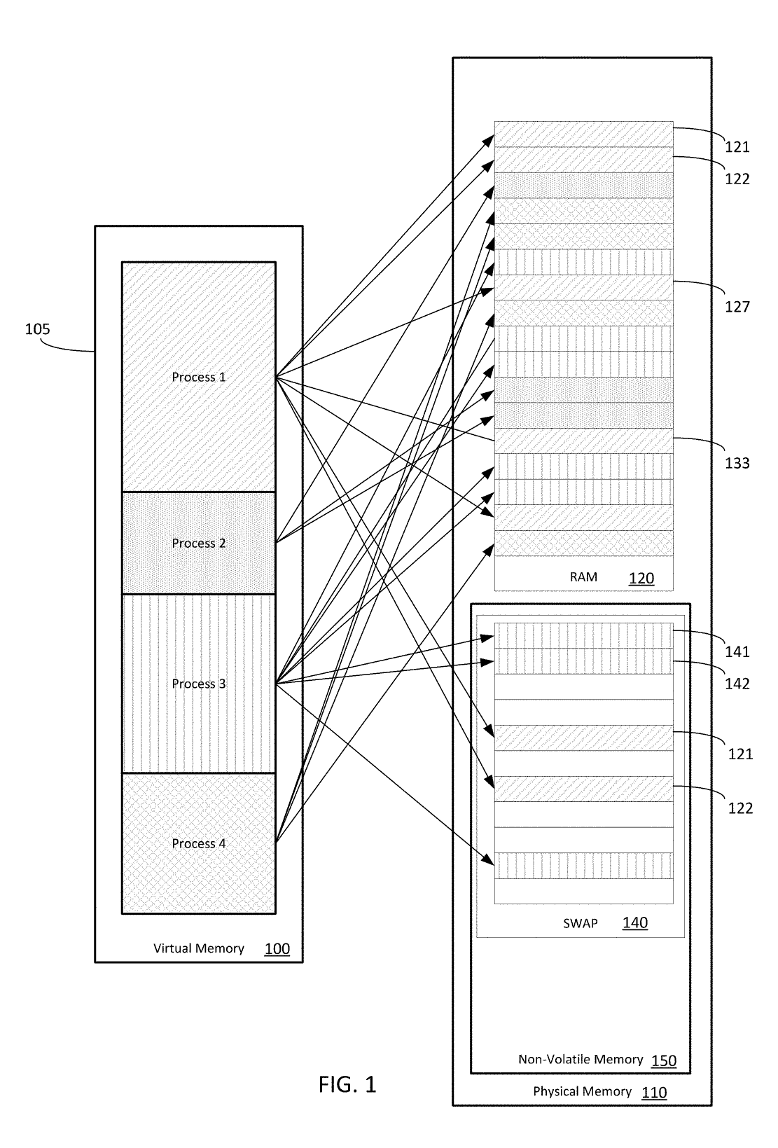

FIG. 1 shows how in a virtual memory 100, data from various processes can have virtual addresses that are sequential and contiguous, though their addresses in physical memory 110 are not sequential and not contiguous. For example, in FIG. 1, Process 1 has one contiguous virtual address space 105, but its data is divided up into several pages 121, 122, 127, and 133 which have corresponding physical addresses in RAM 120 that are located in non-contiguous spaces. Throughout this disclosure, the terms “sequential spaces” “sequential blocks,” “contiguous spaces,” and “contiguous blocks” may be used interchangeably and refer to physical, readable and writeable memory blocks that are located next to each other with no other blocks in between.

FIG. 1 also illustrates that some processes have pages of data that have physical addresses in a swap storage location 140 (“swap”) located in a non-volatile memory 150. Various reasons for why certain pages may be temporarily stored in swap 140 will be discussed later in the disclosure. As shown, Process 3 has pages 141 and 142 stored in swap 140. A page table that maps virtual addresses to physical addresses will be discussed throughout the disclosure. Some operating systems direct pages that are written to swap to be stored in either swap “partitions” or swap “files;” aspects of the present disclosure may apply to either type of swap storage.

When an operating system is running many processes, a computing device's RAM may run out of physical space to store process data. For example, if an operating system user opens many programs, or opens a few programs that run processes requiring a high amount of RAM, eventually, the RAM may become full. When the RAM becomes full, but space is still needed, a memory management subsystem may transfer certain pages from the RAM to temporarily store them in swap. It is more inefficient for a process to retrieve data from swap than to retrieve it from RAM, because of the properties of non-volatile memory that are commonly used (i.e., hard disk drives and flash storage). However, utilizing swap as a sort of “last resort” type of storage is better than not having needed data stored at all. The alternative to having data stored in swap would be to completely kill a process. Typically, a memory management subsystem implements an algorithm to determine which pages get transferred to swap, which involves determining which pages are least likely to be used again in the near future, or at all. Various methods may be used to determine which pages are least likely to be used, including lists and algorithms that detect how long a page has gone without being “touched.” The swapping algorithm used in Linux is known as the “Least Recently Used” (“LRU”) algorithm. Throughout this disclosure, a page may be referred to as being touched whenever it is actively used for process execution by a central processing unit (CPU), such as by being read from memory or written to memory.

The present disclosure provides a method for increasing the spatial locality of pages that belong to a process in swap through a process referred to herein as “binning.” At a high level, binning is a way to group data that belongs to the same process together in a swap disk. Ordinarily, the LRU algorithm or other similar swapping algorithms cause pages from the same process to be written to swap in non-sequential disk space. This occurs because the operating system algorithms manage memory based primarily on which pages have gone the longest without being used, and with little or no regard for what process the pages belong to.

Operating systems typically use several lists to manage processes and their pages that are allocated to memory. In Linux, for example, three types of lists are typically used. These include “file system cache data lists,” which include two subtypes known as “active file list” and “inactive file list.” Another type of list is known as “unevictable,” which contains allocated memory that cannot be moved to swap. The third type of lists are “anonymous” lists, which have two subtypes known as “active anonymous” and “inactive anonymous.” In Linux, the pages that may ultimately be moved to swap are managed using these two lists—Active Anonymous and Inactive Anonymous. These lists are called “anonymous” because the system does not necessarily know which process the pages belong to without referring to a page table. Aspects of a page table will be described throughout the disclosure. Though the present disclosure refers to the specifically named data structures called the “Active Anonymous list” and the “Inactive Anonymous list” which are their names in Linux, aspects of the disclosure may also apply to the operating systems, data structures, and/or lists that function similarly, even if they are known by other names in other operating systems. A list is one of several types of data structures used to physically allocate and organize memory.

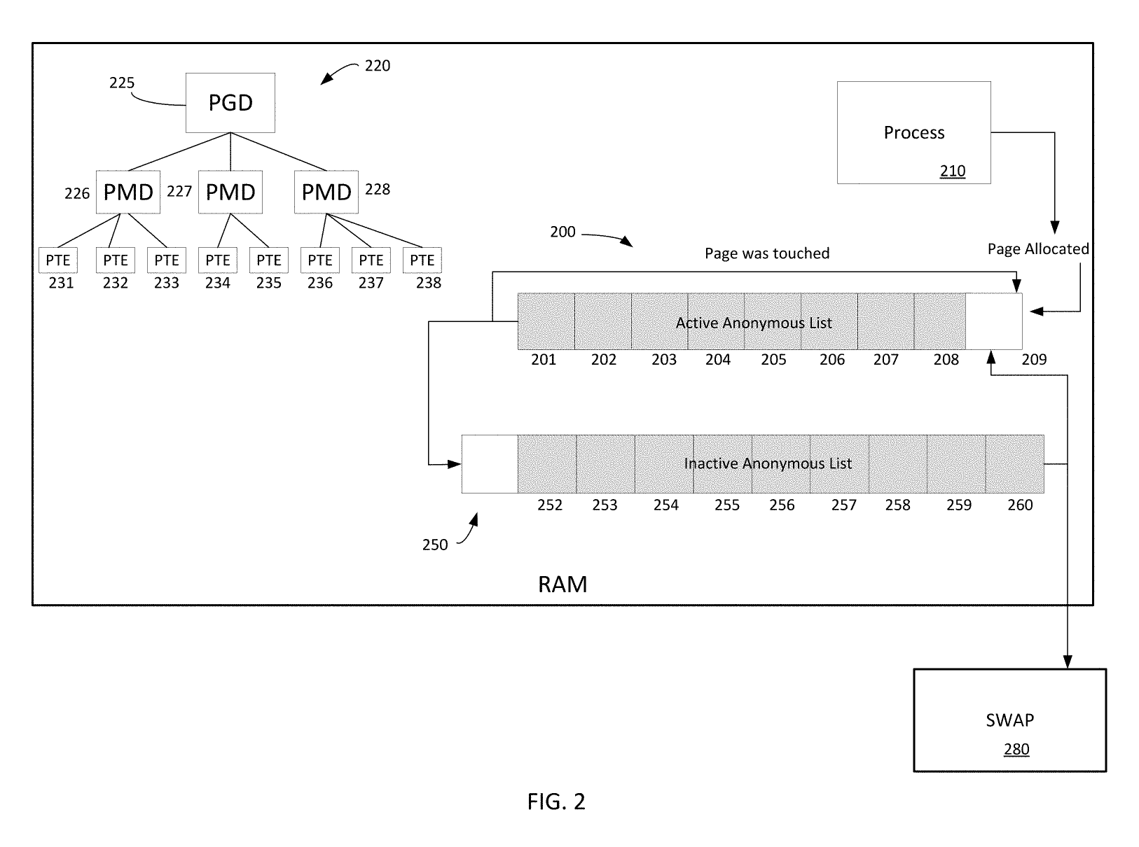

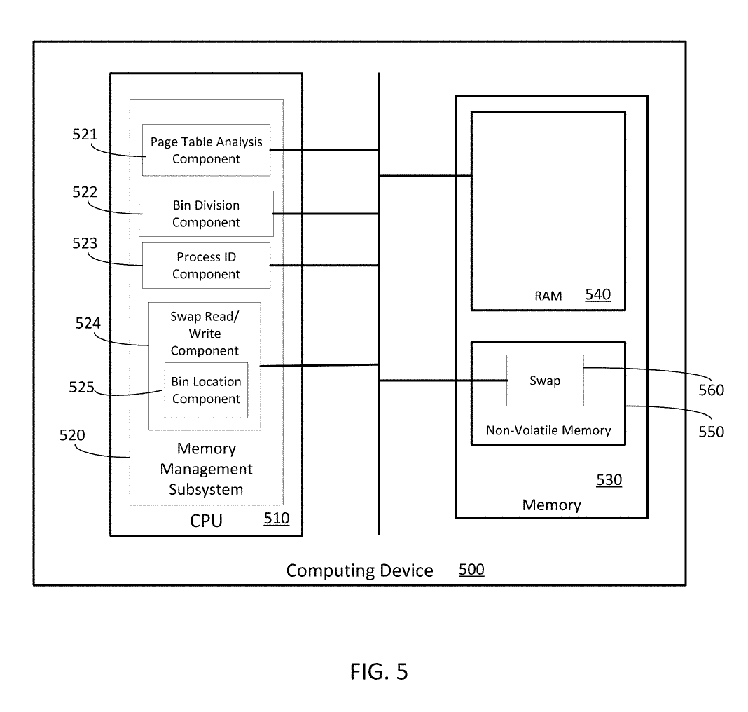

Turning briefly to FIG. 5, shown is a logical block diagram depicting components that may be used to implement aspects of the present disclosure. Throughout the descriptions accompanying FIGS. 2-4 and 6-7, simultaneous reference may be made to the components described in FIG. 5. FIG. 5 is not intended to be a hardware diagram; rather, it represents logical blocks that may be implemented in hardware alone, a combination of hardware and software, or software alone. As shown, a computing device 500 may comprise a CPU 510. The CPU 510 may execute a memory management subsystem 520, which may itself comprise a page table analysis component 521, a bin division component 522, a process ID component 523, and a swap read/write component 524 which comprises a bin location component 525. The computing device may also comprise a system memory 530, which itself may comprise RAM (volatile memory) 540 and non-volatile memory 550. The non-volatile memory may itself comprise swap 560. Aspects of the various components in FIG. 5 will be describer in further detail throughout the disclosure.

FIG. 2 illustrates how pages are placed in the Active Anonymous list 200 and the Inactive Anonymous list 250 when dynamic memory is allocated or recently accessed. A blank space 209 may represent a 4 KB block of memory that is available for the allocation of a 4 KB page. Because it is not necessarily known to which process a page belongs on these anonymous lists, pages belonging to the same process may not be physically allocated next to each other on the Active Anonymous list 200. That is, pages of various processes may be interspersed on the physical memory space used for the Active Anonymous list 200. When any page is allocated to Active Anonymous list, a flag is set to indicate that the page has not been accessed. If the page is later accessed by a process the same flag will be set to indicate the page was accessed. The lists will be scanned when the amount of memory available is low. The page inserted into the Active Anonymous list 200 will remain on the list as long as the accessed flag is set when the list is processed for low memory. If the flag is not set to indicate it has not been accessed for a page in the Active list when the list is processed, the page is moved from the Active Anonymous list to the Inactive Anonymous list 250. The movement of a page from the Active Anonymous list 200 to the Inactive Anonymous list may be visualized as the pages moving from right to left (i.e., from block 209 to the location of page 201), with the most recently active page being on the right (209) and least recently active (201) being on the left. Though this visualization is conceptually helpful, it should be appreciated that physical memory blocks are not necessarily ordered in a linear fashion according to how recently it was allocated, nor do they move linearly from one block of physical memory to another. For example, a page may be touched at any time while it is on the Active Anonymous list 200, at which time its accessed flag may be reset, when processing the Active Anonymous list 200, this page would be moved from the end of the list to the beginning.

In current approaches, such through the LRU algorithm, pages that have not been touched recently are placed on the Active Anonymous list 200. If the pages continue to not be touched, the pages get places on the Inactive Anonymous list 250. The pages 252-260 on the Inactive Anonymous list 250 represent pages that have not been touched recently enough to be on the Active Anonymous List 200 but have not yet been written to swap 280. As discussed previously, pages may be written to swap 280 if there is not enough room in RAM to store inactive pages. While pages are on the Inactive Anonymous List 250, they may still be placed back on the Active Anonymous list 200 if they are touched. The pages 252-260 on the Inactive Anonymous List 250 are depicted showing that the pages will be written to swap 280 in order from right to left (i.e., page 260, then 259, then 258, etc.). Though only one process 210 is depicted in FIG. 2, operating systems often run many processes simultaneously. Each process has many pages, and the pages of different processes often get placed on the Active Anonymous List 200 next to each other, and subsequently get placed on the Inactive Anonymous list 250 next to each other. As a result, pages of different processes get written next to each other in swap.

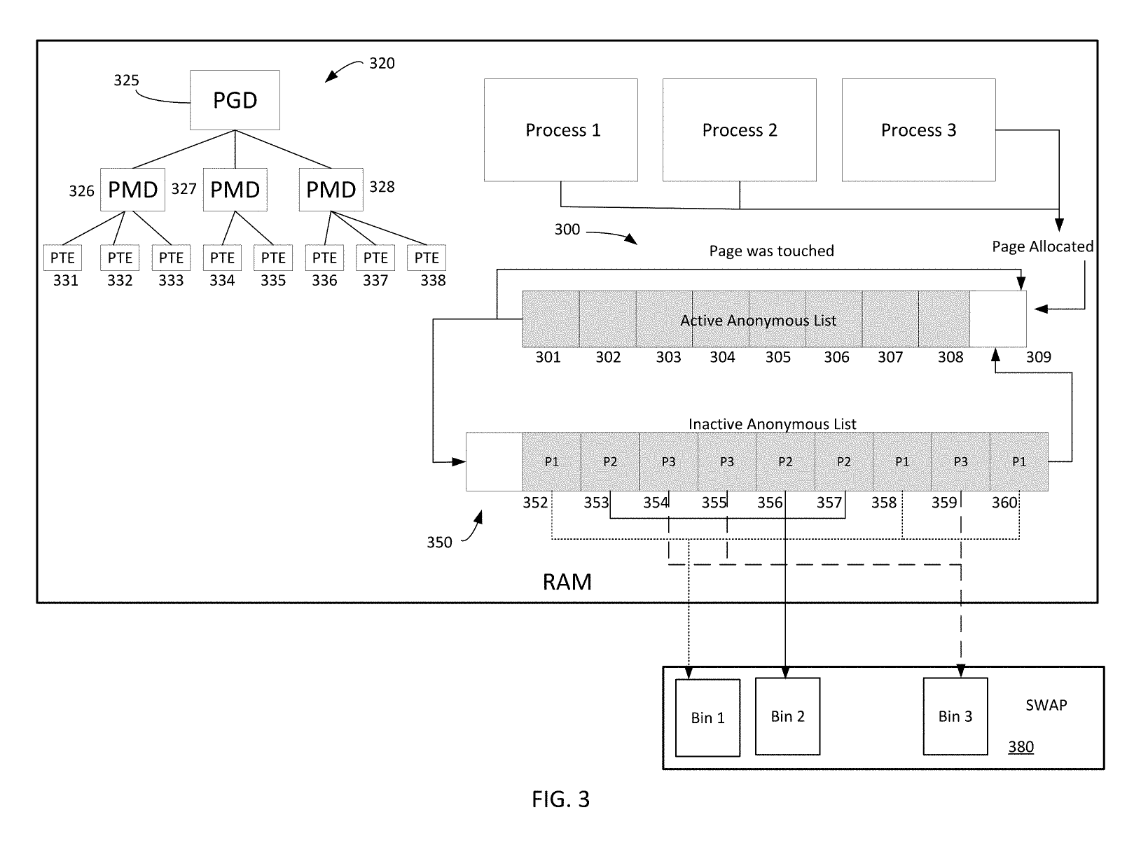

Turning now to FIG. 3, which depicts aspects of a method of the present disclosure, three different processes, Process 1, Process 2, and Process 3 are shown. Each of the Processes 1, 2, and 3 allocates pages to the Active Anonymous list 300, and the pages that are least likely to be used again are placed on the Inactive Anonymous List 350, similar to FIG. 2. The pages 352-360 on the Inactive Anonymous List 350 are labeled in the diagram according to what process they belong to, with “P1” signifying Process 1, “P2” signifying Process 2, and “P3” signifying Process 3. As discussed with reference to FIG. 2, the order in which the pages would ordinarily be written to swap is depicted from right to left. As shown, pages of the same processes are not located next to each other in the Inactive Anonymous List 350.

An aspect of the disclosure is that swap may be organized by the memory management subsystem into “bins” by the bin division component 522 of FIG. 5. For the purposes of the present disclosure, the term “bins” may be used to refer to a plurality of sequential, contiguous blocks of physical memory in swap that are designated for one or more particular processes. FIG. 3 shows three bins, Bin 1, Bin 2, and Bin 3 in swap. Bins 1, 2, and 3 are designated for pages for Processes 1, 2, and 3, respectively. According to the present disclosure, when a page is ready to be evicted from the Inactive Anonymous List 350, it may be written to its designated bin. The method for locating the matching bin for each particular page will be described in further detail later in this disclosure. As shown, page 360 (P1) is written to Bin 1, then page 359 (P3) is written to Bin 3, page 358 (P1) is written to Bin 1, page 357 (P2) is written to Bin 2, and so on. As a result of this method, writes to swap may be to non-sequential memory slots in swap. That is, page 360 (P1) may be written to a first slot in Bin 1, and then page 359 (P3) will be written to a first slot in Bin 3, which are not next to each other. This will happen when there are many distinct process in the Inactive Anonymous list (350). Such non-sequential writes are not necessarily disadvantageous because even if non-sequential writes take longer than sequential writes, the writes may be done in the background without being noticed by a user. That is, a user will not likely notice a write to swap of data that is being written there because it is not likely to be needed. In contrast, non-sequential reads from swap are likely to be noticed because the data is needed. Sequential reads from swap are substantially faster than non-sequential ones. Even minor improvements in the spatial locality of pages being read from swap can result in significant performance improvements.

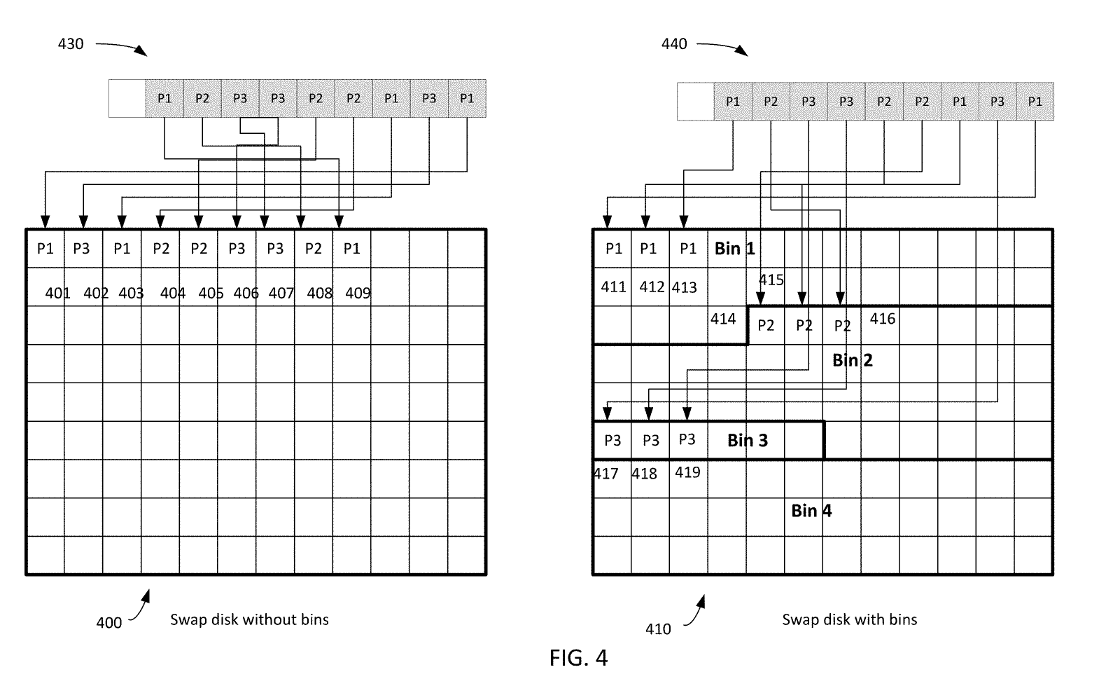

A process may access RAM memory during its regular execution. If the page that the process is accessing is not available, the operating system will read this page from disk. Having to read a page from non-volatile storage is known as a “a page miss.” A page miss indicates that the page has been written to swap and needs to be retrieved from there. Because reads from swap can take a relatively long time, some memory management subsystems attempt to mitigate any latency by “reading ahead” for other pages that may be in swap and may be needed by the process. When the system reads ahead, it typically retrieves other pages from swap that are nearby in spatial locality to the requested page. However, as previously discussed, the implementation of the LRU algorithm often results in pages of different processes being written to swap next to each other. For example, referring briefly to FIG. 4, a swap disk 400 shows pages 401-409 having been written to swap as they ordinarily would, which is according to their order in the Inactive Anonymous List 430. As shown, pages belonging to the same process are not necessarily written next to each other. The order of how the pages are written decreases the effectiveness of reading ahead, because the when the system retrieves pages near the requested page, these nearby pages may not belong to the same process, and therefore may be read out of swap unnecessarily. For example, if Process 1 requires page 401, the operating system may read ahead and retrieve pages 402, 403, and 404 out of swap. However, page 402 belongs to Process 3, and page 404 belongs to Process 2. Page 403, which belongs to Process 1, may have been advantageously retrieved and used by Process 1, but pages 402 and 404 were not. These unnecessary reads may be inefficient, because reads from swap can take a noticeable amount of time and may be perceived by a user.

An aspect of the disclosure is that when a page is placed on a list in RAM (e.g., the Active Anonymous List), a process ID is created and stored with the page metadata in the page's page table entry by the process ID component 523 of FIG. 5. Referring back to FIG. 3, each of the page table entries 331-338 may store the process IDs for each page of Process 1, Process 2, and Process 3. These process IDs may be located by the page table analysis component 521 of FIG. 5. The process ID may be a numerical value, and in many embodiments, may be a very large number commensurate with how many process a computer can run. By associating a process ID with each page, pages can be grouped together according to their processes in bins through the method described herein. When a page is on the Inactive Anonymous list it is subject to being written to swap. According to the present disclosure, the memory management subsystem looks at the process ID of pages when they are ready to be evicted in order to write all pages of the same process to the same bin.

It is contemplated that at least some of the particular processes that get written to swap are known in advance, and that the amount of space required by these particular processes is also known. Therefore, sizes of bins in swap may be pre-determined and optimized for a particular target process. A commonly used page size is 4 KB, but entire processes are typically on the order of megabytes. Therefore, bins may be several megabytes in size. FIG. 4 illustrates how an area of swap 410 may be divided into bins (Bins 1, 2, 3, and 4) of various sizes. In implementation, actual swap disks may comprise thousands of pages or more, and dozens, hundreds, or thousands of bins. Although the bins may be sized to store an entire process, it is possible that bins may overflow, and that some pages of a particular process will not be written to their intended bin. In such a case, though, the spatial locality of the pages that are in the same bin may still greatly improve the performance of reads out of swap.

In order to use the process ID to write a page to the intended bin, the memory management subsystem may create and utilize a hash function to identify a bin number. As previously noted, the process ID may be a very large numerical value, and as such, may need to be converted to a corresponding bin number which may be many orders of magnitude smaller. For example, a process ID may be 2³², but there may be less than 100 bins. In order to convert the process ID to a bin number, an exemplary hash function could comprise multiplying the process ID by another numerical value (e.g., 256) and then dividing by the swap disk size. The resulting remainder of the division would then indicate the bin number in which the page should be written. The hash function described herein is just one example of a possible hash function. Any hash function may be used, though ideally a given hash function will result in highly accurate placement of the page in the correct bin. The memory management subsystem (in particular, the bin location component 525 of FIG. 5) may then sequentially search the bin for an empty slot and then write the page to the empty slot via the swap read/write component 524.

As shown in FIG. 4, in swap disk 410, the pages from the Inactive Anonymous list 440 are written to sequential slots in bins designated for their processes. The pages are written in order that they are scheduled to be written according to the list (i.e., from right to left), so page 411 (P1) is first written to Bin 1. Then pages 417 (P3) is written to Bin 3, then page 412(P1) to Bin 1, then page 414 (P2) to Bin 2, and so on. Though not shown, an entire bin may be filled with pages of its process. At any point when pages are needed for a particular process, they may be read out of swap. If, for example, Bin 2 was partially or fully filled, and Process 2 needed to be read out of swap, all the pages in Bin 2 could be read from in one sequential access. An additional advantage to having these bins is that once a large sequential read is performed, a large sequential set of slots is again available for subsequent writes.

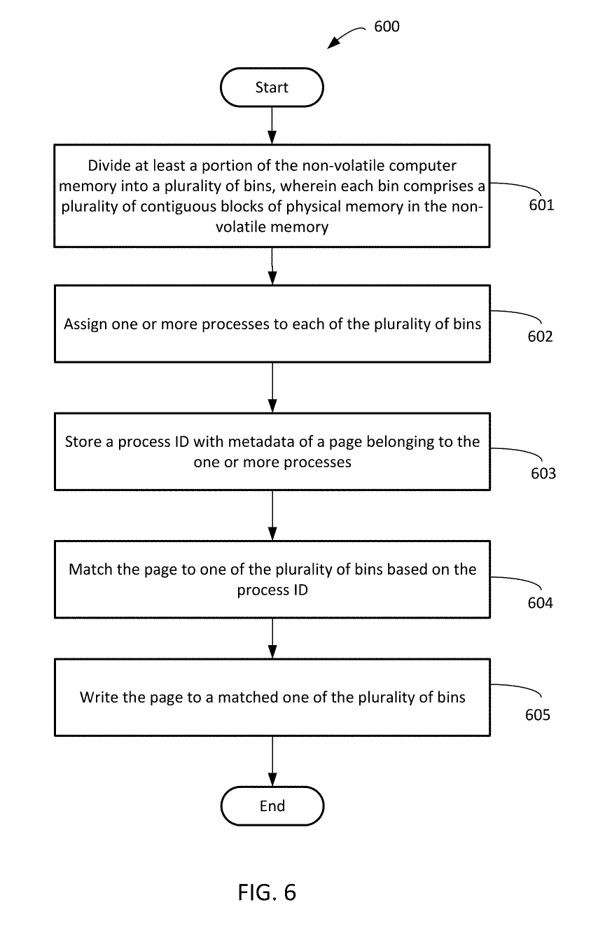

FIG. 6 is a flowchart which may be traversed to depict a method 600 in accordance with embodiments of the disclosure. The method may first include, at Block 601, dividing at least a portion of the non-volatile computer memory into a plurality of bins, wherein each bin comprises a plurality of contiguous blocks of physical memory in the non-volatile memory. The bins may be divided by bin division component 522. Next, the method may comprise, at Block 602, assigning one or more processes to each of the plurality of bins. The assigning may also be implemented by bin division component 522. Then, at Block 603, the method may comprise storing a process ID with metadata of a page belonging to one of more processes. The storing may be implemented by the process ID component 523. Then, at Block 604, the method may comprise matching the page to one of the plurality of bins based on the process ID, which may be accomplished by the page table analysis component. The writing may be implemented by the swap read/write component 521 and the bin location component 525. Then, at Block 605, the method may comprise writing the page to a matched one of the plurality of bins by the swap read/write component 524.

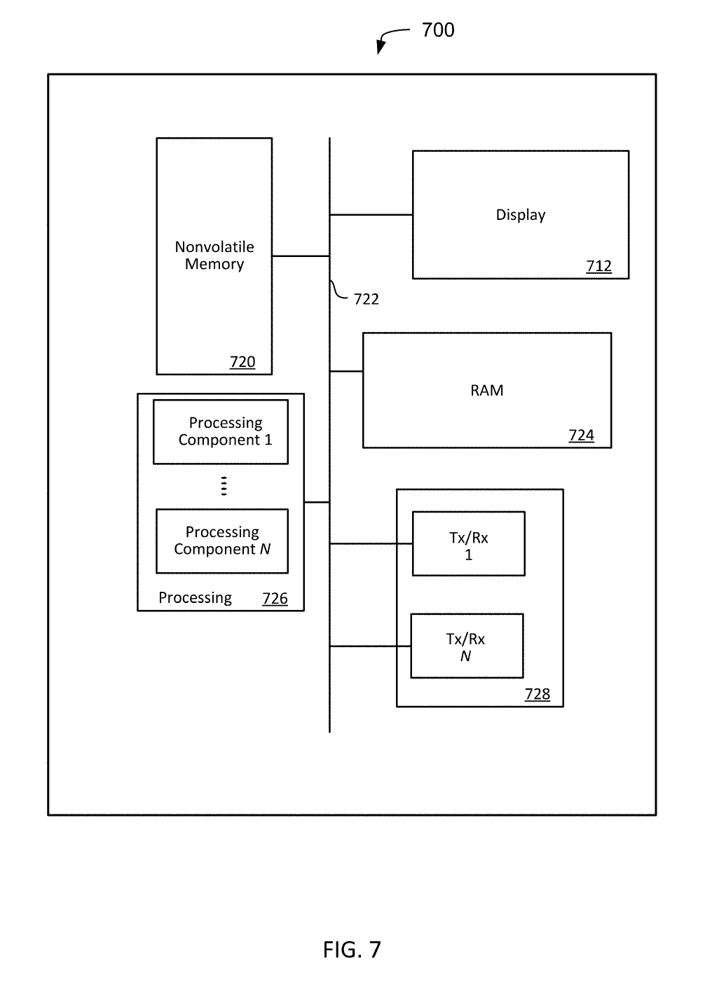

Referring next to FIG. 7, shown is a block diagram depicting high-level physical components of an exemplary computing device 700 that may be utilized to realize a computing device of the present disclosure. As shown, the computing device 700 in this embodiment includes a display portion 712, and nonvolatile memory 720 (similar to non-volatile memory 750 of FIG. 7) that are coupled to a bus 722 that is also coupled to random access memory (“RAM”) 724 (similar to RAM 740 of FIG. 7), and a processing portion (which includes N processing components) 726. The processing portion 726 may correspond to the CPU 710 of FIG. 7. Although the components depicted in FIG. 7 represent physical components, FIG. 7 is not intended to be a hardware diagram; thus many of the components depicted in FIG. 7 may be realized by common constructs or distributed among additional physical components. Moreover, it is certainly contemplated that other existing and yet-to-be developed physical components and architectures may be utilized to implement the functional components described with reference to FIG. 7.

This display portion 712 generally operates to provide a presentation of content to a user. In several implementations, the display is realized by an LCD or OLED display. In general, the nonvolatile memory 720 functions to store (e.g., persistently store) data and executable code including code that is associated with the functional components described herein, in addition to other functions and aspects of the nonvolatile memory unique to the present disclosure. In some embodiments for example, the nonvolatile memory 720 includes bootloader code, modem software, operating system code, file system code, and code to facilitate the implementation of one or more portions of the memory management subsystem 720.

In many implementations, the nonvolatile memory 720 is realized by flash memory as described throughout the disclosure (e.g., NAND or ONENAND™ memory), but it is certainly contemplated that other memory types may be utilized as well, such as traditional hard disk drives. Although it may be possible to execute the code from the nonvolatile memory 720, (e.g., via the swap read/write functionality described herein) the executable code in the nonvolatile memory 720 is typically loaded into RAM 724 and executed by one or more of the N processing components in the processing portion 726. In many embodiments, the system memory may be implemented through the nonvolatile memory 720, the RAM 724, or some combination thereof.

The N processing components in connection with RAM 724 generally operate to execute the instructions stored in nonvolatile memory 720 to effectuate the functional components described herein. As one of ordinarily skill in the art will appreciate, the processing portion 726 may include a video processor, modem processor, DSP, and other processing components.

In conclusion, embodiments of the present invention improve user experience by reducing latency and/or power consumption associated with reads from and writes to swap. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention.

What is claimed is:

1. A method for using volatile and non-volatile computer memory, the method comprising:
dividing at least a portion of the non-volatile computer memory into a plurality of bins, wherein each bin comprises a plurality of contiguous blocks of physical memory in the non-volatile memory;
assigning one or more processes to each of the plurality of bins;
storing a process ID with metadata of a page belonging to the one or more processes;
matching the page to one of the plurality of bins based on the process ID; and
writing the page to a matched one of the plurality of bins.

2. The method of claim 1, further comprising:
storing a particular process ID with metadata of each of a plurality of pages belonging to a particular processes;
matching each of the plurality of pages of the particular process to a particular one of the plurality of bins based on the particular process ID; and
writing at least two of the plurality of pages belonging to a particular process to at least two contiguous slots in the particular one of the plurality of bins.

3. The method of claim 1, wherein matching the page to one of the plurality of bins based on the process ID comprises:
creating a hash value of the process ID.

4. The method of claim 3, wherein creating the hash value comprises:
multiplying a numerical value of the process ID by a predetermined number;
dividing a resulting product of the multiplying by a size of the non-volatile memory;
utilizing a remainder of the division to identify a physical location in the non-volatile memory.

5. The method of claim 1, further comprising:
sequentially searching for a first empty slot in the matched one of the plurality of bins; and
writing the page to the first empty slot.

6. The method of claim 1, wherein the size of each of the plurality of bins is predetermined.

7. The method of claim 6, wherein the size of the bins corresponds to a target size based on properties of one or more of the processes.

8. A computing device comprising:
volatile memory;
non-volatile memory; and
a hardware processor configured to execute a memory management subsystem that performs a method for utilizing the volatile memory and non-volatile memory, the method comprising:
dividing at least a portion of the non-volatile computer memory into a plurality of bins, wherein each bin comprises a plurality of contiguous blocks of physical memory in the non-volatile memory;
assigning one or more processes to each of the plurality of bins;
storing a process ID with metadata of a page belonging to the one or more processes;
matching the page to one of the plurality of bins based on the process ID; and
writing the page to a matched one of the plurality of bins.

9. The computing device of claim 8, wherein the method further comprises:
storing a particular process ID with metadata of each of a plurality of pages belonging to a particular processes;
matching each of the plurality of pages of the particular process to a particular one of the plurality of bins based on the particular process ID; and
writing at least two of the plurality of pages belonging to a particular process to at least two contiguous slots in the particular one of the plurality of bins.

10. The computing device of claim 8, wherein matching the page to one of the plurality of bins based on the process ID comprises:
creating a hash value of the process ID,
wherein creating the hash value comprises:
multiplying a numerical value of the process ID by two a predetermined number;
dividing a resulting product of the multiplying by a size of the non-volatile memory;
utilizing a remainder of the division to identify a physical location in the non-volatile memory.

11. The computing device of claim 8, wherein the method further comprises:
sequentially searching for a first empty slot in the matched one of the plurality of bins; and
writing the page to the first empty slot.

12. The computing device of claim 8, wherein the size of each of the plurality of bins is predetermined.

13. The method of claim 12, wherein the size of the bins corresponds to a target size based on properties of one or more of the processes.

14. A non-transitory, tangible computer readable storage medium, encoded with processor readable instructions to perform a method for using volatile and non-volatile computer memory, the method comprising:
dividing at least a portion of the non-volatile computer memory into a plurality of bins wherein each bin comprises a plurality of contiguous blocks of physical memory in the non-volatile memory;
assigning one or more processes to each of the plurality of bins;
storing a process ID with metadata of a page belonging to the one or more processes;
matching the page to one of the plurality of bins based on the process ID; and
writing the page to a matched one of the plurality of bins.

15. The non-transitory, tangible computer readable storage medium of claim 14, wherein the method further comprises:
storing a particular process ID with metadata of each of a plurality of pages belonging to a particular processes;
matching each of the plurality of pages of the particular process to a particular one of the plurality of bins based on the particular process ID; and
writing at least two of the plurality of pages belonging to a particular process to at least two contiguous slots in the particular one of the plurality of bins.

16. The non-transitory, tangible computer readable storage medium of claim 14, wherein matching the page to one of the plurality of bins based on the process ID comprises:
creating a hash value of the process ID.

17. The non-transitory, tangible computer readable storage medium of claim 16, wherein creating the hash value comprises:
multiplying a numerical value of the process ID by a predetermined number;
dividing a resulting product of the multiplying by a size of the non-volatile memory;
utilizing a remainder of the division to identify a physical location in the non-volatile memory.

18. The non-transitory, tangible computer readable storage medium of claim 14, wherein the method further comprises:
sequentially searching for a first empty slot in the matched one of the plurality of bins; and
writing the page to the first empty slot.

19. The non-transitory, tangible computer readable storage medium of claim 14, wherein the size of each of the plurality of bins is predetermined.

20. The non-transitory, tangible computer readable storage medium of claim 19, wherein the size of the bins corresponds to a target size based on properties of one or more of the processes.
